(19) United States
(12) Patent Application Publication
(10) Pub. No.: US 2025/0083758 A1
(43) Pub. Date: Mar. 13, 2025

(54) TABLE ACCESSORY FOR A-FRAME TRAILER

(71) Applicant: Marty Williams, Worland, WY (US)

(72) Inventor: Marty Williams, Worland, WY (US)

(21) Appl. No.: 18/829,093

(22) Filed: Sep. 9, 2024

Related U.S. Application Data
(60) Provisional application No. 63/581,558, filed on Sep. 8, 2023.

(51) Int. Cl. B62D 63/08

(52) U.S. Cl. CPC B62D 63/08

(57) ABSTRACT

A trailer accessory for a jack tower where the accessory is a table, the table rests on three bases, the first base is a top plate across the top of the jack tower and the second and third bases are first and second arms that extend outwardly from the top of the jack tower, these first and second arms end at or past the end of the table and are connected to uprights where the first upright connects to the first arm at one end and to a first leg of an A-frame trailer at a second end, and the second upright connects to the second arm at one end and to a second leg of the A-frame trailer at the other end, thus creating a solid base for the table.

### BACKGROUND OF THE INVENTION

There exist numerous hitch mounts for trailer accessories to carry supplies and equipment, such as, bicycles and other cargo carriers for transportation of such items on, or on the rear of, a vehicle, trailer or chassis. As used herein, a vehicle is a thing used for transporting people or goods and can be a car, a truck, a trailer, a trailer frame or chassis. Conventional carriers have mounts that are generally dedicated to a particular item, such as, for example, a bicycle or cargo carrier. Hitch-mounted carriers are popular for use on SUVs and other vehicles that have hitch or tow attachments. A bracket or hitch mounted tube on which such conventional carrier systems are permanently or semi-permanently mounted typically include securing mechanisms corresponding to a particular piece of equipment, case, or article, and lack adaptability to other types of surfaces or cargo.

That is, dedicated carriers have distinct mounting mechanisms and carrier frames adapted for fastening and transporting particular equipment, gear or other cargo type. For example, bicycles, jet or snow skis, snowboards, as well as surfboards and wakeboards require dedicated mounting mechanisms having distinct receiver tubes and brackets.

In addition, conventional carrier systems typically are limited to mounting systems for a single hitch receiver, and use thereof are preempted when a trailer or other accessory is mounted on the hitch. Moreover, such prior art systems typically are rigidly aligned to accommodate specific equipment or cargo configurations and therefore are limited to a dedicated, single use.

With regard to bicycle carriers, even different cycle species, such as unicycles, road bicycles, mountain bicycles with different frame configurations or children's bicycles, each may require distinct carriers. For example, conventional hitch mounted carriers typically have welded crossbars with horizontally extending arms positioned to accommodate the frames and handlebars of standard bicycle sizes. Such bicycle carrier frames typically are not adaptable to different bicycle frame designs, alternative bicycle styles, such as full suspension mountain bikes, or even children's bicycles. Also, they are not able to be reconfigured or altered in any way to carry alternative cargo or equipment. In addition, conventional carriers are often heavy and awkward to align and mount onto the vehicle.

For example, hitch mounted carriers typically have a square bar or tube that is fitted to slide into a receiver mounted on the vehicle. A pin engages the bar or tube in the receiver to secure the carrier to the vehicle and a mounting bar is permanently mounted onto the tube with horizontally extending arms onto which a bicycle is secured. These prior art carriers are heavy, and awkward to align and mount onto the vehicle.

Also, the receivers and mounting mechanisms of conventional cargo carriers typically are not adaptable to alternative carrier configurations and applications. Different mounting mechanisms and hardware are required for different carriers and to fasten varying cargo types. A further disadvantage of such dedicated systems is their incapacity to accommodate bulky configurations in the limited space behind a vehicle when a trailer is hitched to a vehicle.

Another problem with hitch mounted carriers is that they have to use the vehicle hitch receiver making it unavailable for any other use or application. Since conventional hitch mounted carriers are mounted to the hitch receiver the vehicle hitch may not be used for another use. In other words, once the receiver is used for the first application, say for example, pulling a trailer, then it is unusable for other uses. Often it is necessary to use the hitch receiver for other purposes, such as towing a trailer. In that event, such a conventional hitch-mounted carrier cannot be mounted. U.S. patent application Ser. No. 11/697,294 addresses such and other problems relating to hitch-mounted carriers by providing a system with adjustment mechanisms for mounting a bicycle carrier on a shank above a hitch receiver whereby a trailer or other accessory may be connected to the hitch receiver. It further enables cargo to be mounted above and clear of the heat emanating from the exhaust tailpipe of a vehicle to which a cargo carrier is attached.

In view of the increasing demand for a burgeoning array of recreational equipment, as well as, other equipment, as well as, tools, supplies and other cargo consumers wish to transport to their travel destination, a need persists for yet an additional mounting mechanisms and systems for expanded cargo demands. There is a need for an adaptive mounting, fastening and cargo carrier system to utilize the available space behind and above a vehicle when a trailer is hitched to a vehicle. Specifically, with respect to the present invention claim set there is a need for a cargo carrier system that is useable on a vehicle chassis such as a trailer chassis and more specifically on a trailer chassis tongue, and further with a trailer jack and that can provide additional storage space above the trailer jack and in front of the trailer.

Many drawbacks in the current art of cargo management result from such lack of adaptability, versatility and portability, including limited or singular application cargo mounting mechanisms including receivers, brackets and fasteners. As detailed herein, differing mounting mechanisms, such as receivers and brackets of equipment and carrier cases have in the past required separate and distinct carrier systems. Moreover, these mounting devices are limited to specifically corresponding surfaces, hitch or other receiver tubes, and they typically lack a bumper mount option. Such conventional carrier mounts lack adaptability and portability. Due to such and other drawbacks, conventional carriers require multiple and distinct mounts and brackets and have limited or single application uses where they are suited to single surfaces, rails or bars, depending on the size and shape of the equipment or other cargo.

In sum, there exists nothing in the prior art that provides a versatile, adaptable, readily adjustable cargo carrier adaptable for mounting on vehicles while a trailer hitch is in use for another mechanism and adaptable for mounting equipment or other cargo in a manner optimizing the use of space above or about a trailer hitched to a vehicle. There is also a lack of mounting mechanisms adaptable to various types, sizes and shapes of cargo, such as, for example, recreational or cargo between locations. There is also nothing in the prior art that provides a versatile, adaptable, readily adjustable carrier adaptable for mounting on a vehicle, such as a trailer chassis or any other chassis that utilizes a jack, that optimizes the space above, around or about the trailer jack. The space above and around the jack is empty and is not utilized or used. This is true because the jack itself utilizes this space alone. Because the space is occupied by the jack there has previously been no way to utilize the space above and behind the jack. Thus, there persists a need for a cargo carrier mounting system that overcomes such and other limitations, problems and drawbacks.

### SUMMARY OF THE INVENTION

The present invention solves these and other problems by providing a versatile, adaptive, and portable cargo carrier system for use with vehicles and or with a trailer tongue of a vehicle, such as a trailer. In one embodiment of the present invention an attachment apparatus is used that encompasses a drop leg jack so that a cargo carrying apparatus can be used and where the cargo carrying apparatus is located above the jack, creating a jack tower. The jack tower cargo carrying apparatus then can have a variety of attachment apparatus that allow for other apparatus, such as bicycle carriers, snow board carriers, and the like. In one embodiment there is a Y receiver having a shank and two outwardly angled mounting members with receiving ports to form a flared “U” such that the combined shank and mounting members resemble a “Y” shape. The receiving ports are configured for mated insertion of at least one and preferably two corresponding arm members providing a frame for adaptive attachment of variously sized and shaped cargo or equipment. In one embodiment of the present invention the arm members received in the flared U-shaped receiver preferably comprise square tubes oriented to angle outwardly and are adjustable to an extent equipment or cargo is well supported.

As further described in the detailed description of alternative embodiments below, one embodiment features a nested tube shank sized to correspond to two standard trailer hitch receiver sizes, wherein the outer tube corresponds to trailer hitch receivers conventionally installed on recreational vehicles and the inner tube corresponds to other vehicle trailer hitches.

As illustrated in the drawings and described in detail herein, various embodiments of the present invention deploy mounting members angled outwardly from a shank slidably securable in a trailer hitch receiver or integrally connected to a bumper mount employing flanges of a hat bracket securable in braced engagement to the bumper. Such versatile adaptability and portability of the mounting members according to the present invention thus imparts significant features and advantages thereof. Alternative embodiments of the present invention employing a bumper mount provide a Y receiver integrally affixed to an upper planar surface of a plate with perpendicularly oriented flanges spaced apart a distance corresponding to a vehicle bumper providing a bracketed housing. In particular embodiments, a second opposing planar member with hat bracket flanges corresponding to the bumper is braced in parallel aligned correspondence along the lower surface of the bumper and bolted into tightened engagement with the upper planar member to thereby securely position the Y receiver above the bumper. The bumper mount may alternatively be secured with a pin or clamp fitted for braced, seated engagement with a standard bumper and can be configured to fit alternative bumper sizes.

The present inventions further includes rectangular frame bases providing internal pockets adapted for carrying suitable cargo or equipment while simultaneously orienting the Y receiver to access spaces with adequate area and which further aerodynamic efficiency. Such pockets may be vertically aligned and particularly adapted to standard equipment, such as, for example, a trailer jack, above which arms received in the Y receiver are elevated to access the area above a propane gas tank. Alternatively, a horizontally aligned rectangular pocket may be adapted to a corresponding cargo carrier whereon vertically aligned Y receivers and mounting mechanisms provide for fastening suitably configured items to arms inserted and secured thereto. The following drawings and detailed description of preferred embodiments clarify details and applications of the present invention. Hence, these and other features of the present invention will be evident from the ensuing description of preferred embodiments along with the drawings.

### BRIEF DESCRIPTION OF THE DRAWINGS

FIG. 1 is an elevated view of the present invention.

FIG. 2 is an elevated, partially exploded view of the present invention.

FIG. 3 is another elevated, partially exploded view of the present invention.

FIG. 4 is an elevated, partially exploded view of the present invention.

FIG. 4A is a close up view of one of the fasteners of the present invention.

FIG. 5 2 is an elevated, partially exploded view of the present invention.

FIG. 6 is an elevated view of the tower of the present invention.

FIG. 7A is an elevated view of the tower of the present invention with an accessory attachment added.

FIG. 7B is an elevated, exploded view of the tower of the present invention, showing how an accessory is added to the tower.

FIG. 8 is a top side view of the tower base plate of the present invention.

FIG. 9 is an elevated, partially exploded view of the tower of the present invention with cargo wings attached.

FIG. 10 is front view of the tower of the present invention with cargo wings attached.

FIG. 11 is a side view of the tower of the tower with cargo wings attached.

FIG. 12 is a front side view of the tower of the present invention with cargo wings attached, at an angle, and holding cargo.

FIG. 13 is a front side view of the tower of the present invention with cargo wings attached, at an angle, and holding cargo.

FIG. 14 is a front side view of the tower of the present invention with cargo wings attached at two mounting holes and holding cargo.

FIG. 15 is an elevated view a mounting member of present invention.

### DETAILED DESCRIPTION OF EMBODIMENTS

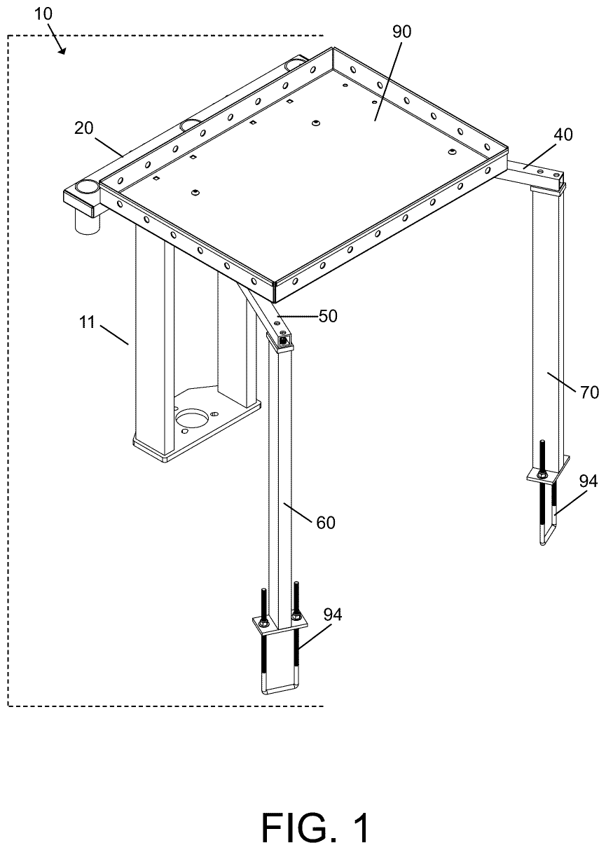

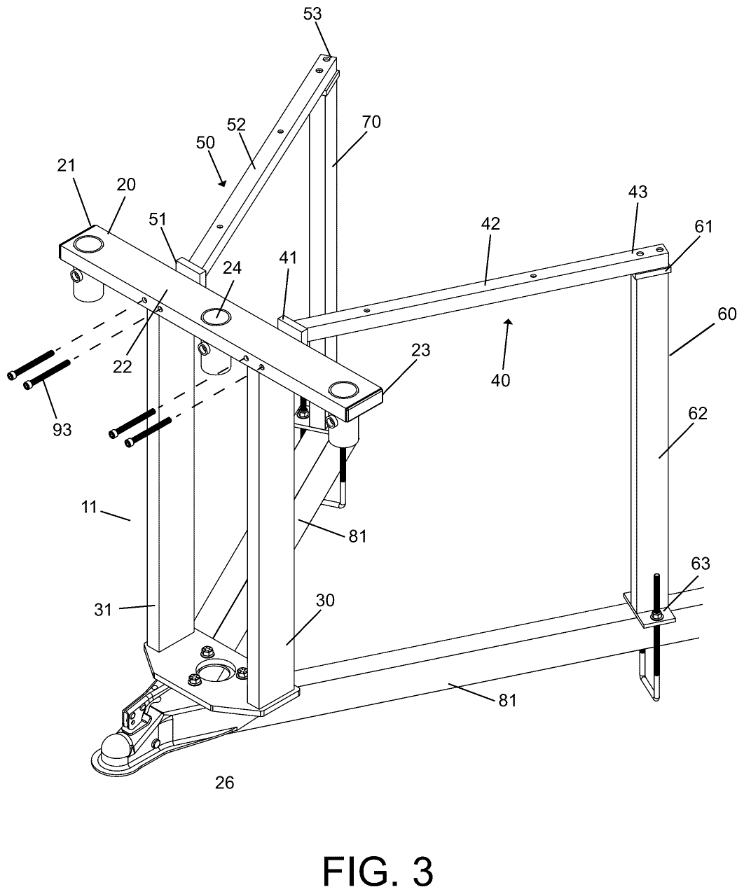

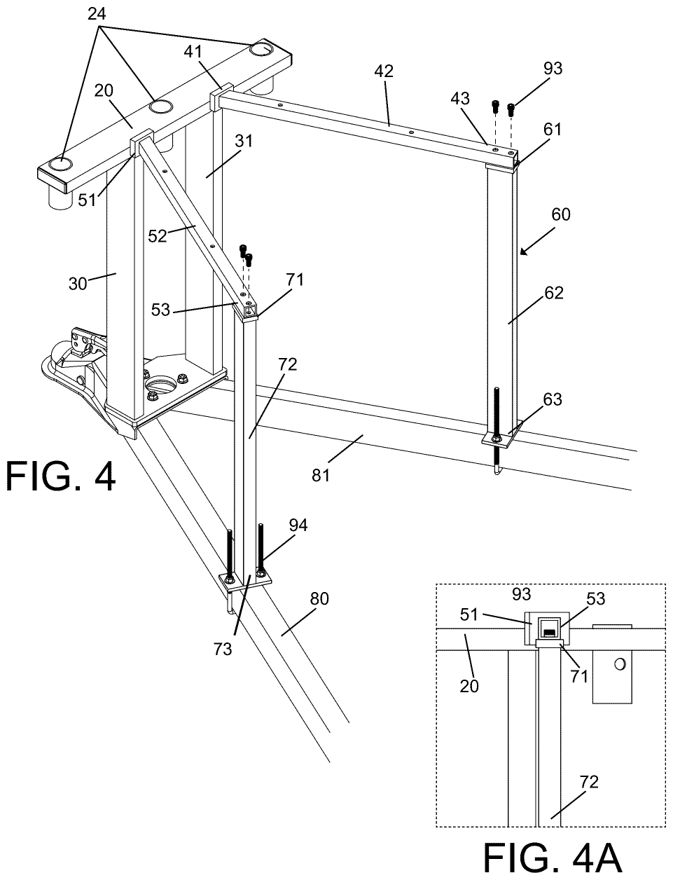

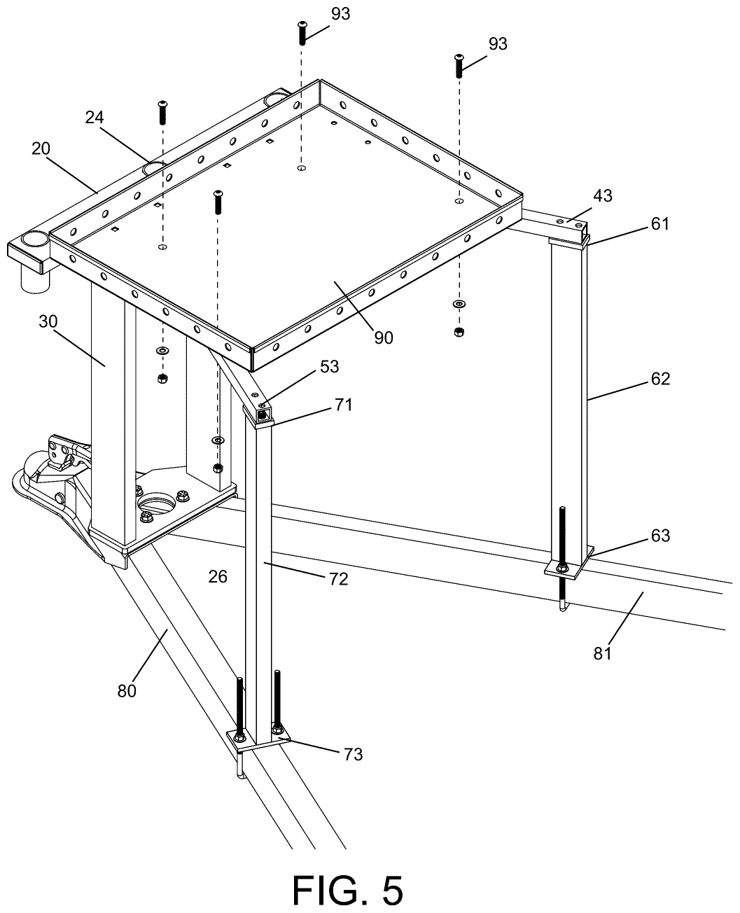

Referring to FIGS. 1-5, embodiments of the present invention include aspects and features for adaptably mounting and fastening about a hitch receiver to transport variously configured cargo and equipment, and specifically, aspects of a tower mount with a table accessory, as further described herein.

The attachments illustrate several embodiment of the present inventions wherein one or more cargo receivers may be attached to a horizontally aligned jack tower 11 base unit attachable to corresponding mounts on trailer tongues, in cargo carriers or containers having lower planar horizontal surfaces, such as, for example, wheeled equipment carriers, box carriers, and pick-up truck beds. In one application, the jack tower base unit 11 provides a jack mount assembly, as shown in use in the attachments wherein a jack is mounted on a jack mounting plate. In these embodiments the receivers can be slidably inserted in accessory mount on a top member 20 of a vertically oriented rectangular frame comprised of opposing jack legs, jack tower legs 30, 31 connected at perpendicular corners to bottom plate assembly and top member. Spaced apart to form triangular oriented fastener holes forming a jack mounting plate configuration to provide a rectangular pocket that is large enough to accommodate a drop leg jack. When used with a jack this assembled unit provides the jack tower base unit assembly base unit.

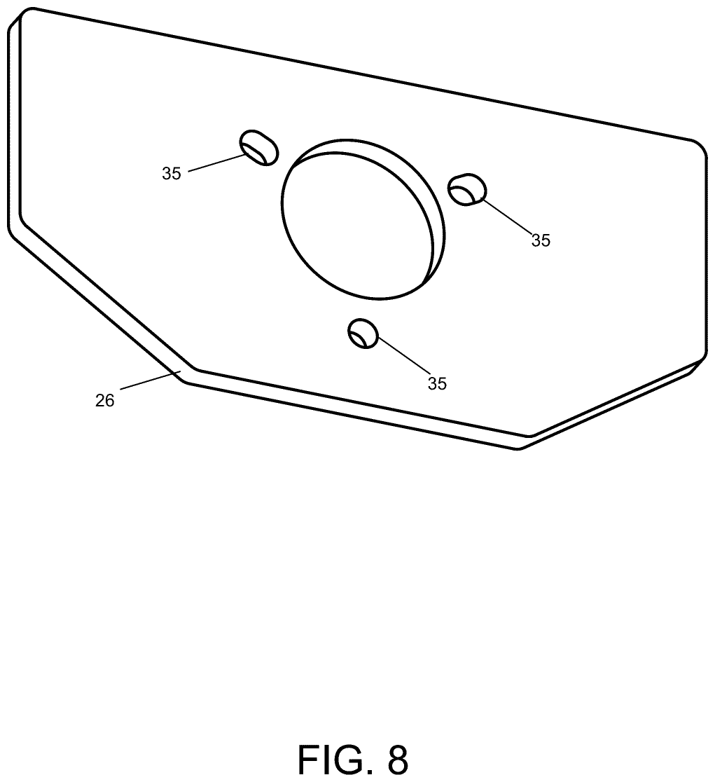

In the embodiment as shown in the attachments and FIGS. 1-14, base unit assembly includes jack mounting plate having a plurality of holes juxtapositioned for mounting a jack typically found on an RV chassis or other trailer type chassis. Holes of jack mounting plate will usually share a common bolt pattern used with a typical A-Frame coupler and jack. The tower base unit 11 has a bottom portion, a middle receiver portion, and an upper portion. Jack legs, jack tower legs 30, 31 attach to the bottom plate assembly directly and are preferably reinforced by corner gusset. The corner reinforcements gussets are placed to transfer load and deflection forces from the jack tower legs to the bottom jack mounting plate 26 and to jack legs 32 and top member 20 forming the jack tower frame of base unit assembly 30. The corner reinforcement gussets 39 are preferably positioned so as to not interfere with the jack mounting plate 26- and three-hole bolt pattern 35. The upper part of the base unit assembly 30 has an accessory mounting hole 24 for attaching a variety of cargo carriers. One accessory mount 24 is preferably vertically aligned above hole 34 and preferably is provided with an opening in base unit assembly 30 such that in the event of an electric failure the jack screw manual override port can be accessed so the jack can be manually controlled without having to remove the base unit assembly 30.

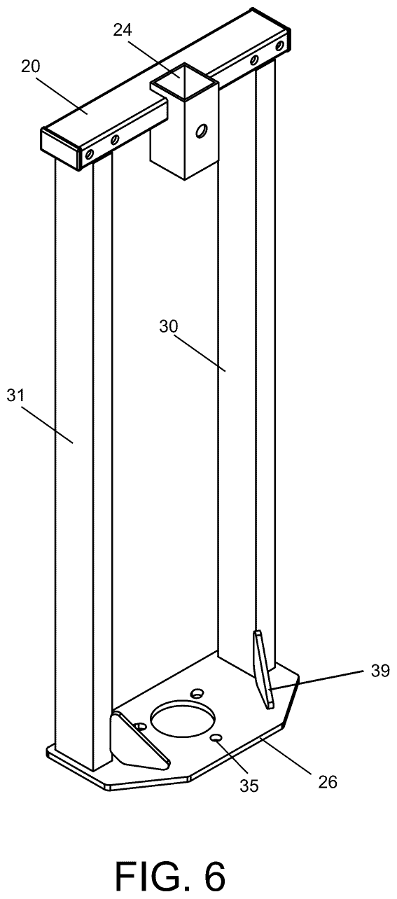

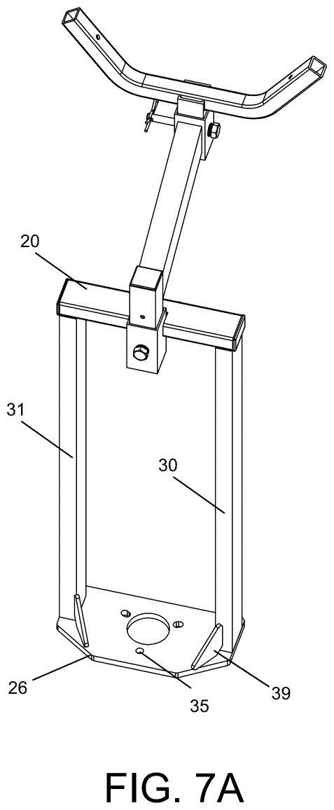

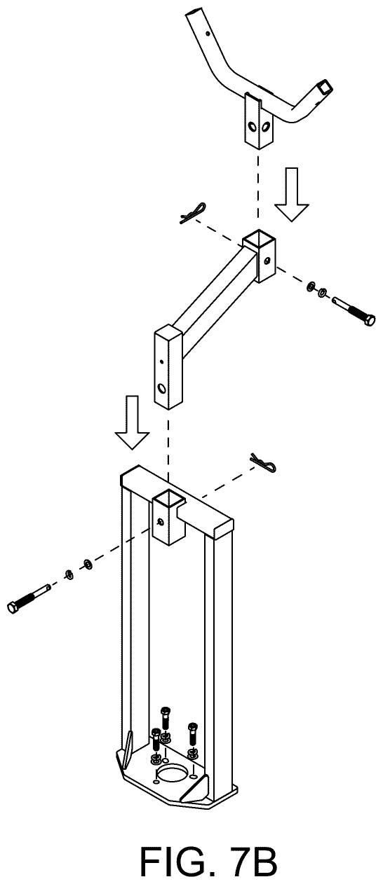

To more clearly define the identified parts, reference is now made to FIGS. 6 through 7B. FIG. 6 shows only the base unit assembly. When this unit is used in conjunction with a jack it could be referred to as the base unit assembly base unit. In this embodiment the base unit assembly has a bottom mounting plate 26 and it is shown with common patterns of fastener holes that typically fit most A-Frame jacks. FIG. 7A illustrates an accessory exchange adapter extending the reach of Y receivers and arms to utilize empty space above the trailer tongue or draw bar to provide added storage.

Referring to FIGS. 6 through 7B illustrate a particularly preferred embodiment of the present invention of a cargo carrier apparatus including base unit assembly for use on a vehicle tongue comprising a bottom member, plate, a first and second jack legs 30, 31, having a middle portion and a top end, of the first and second jack legs 30, 31 and the bottom end of the first and second jack legs are secured to a top side of the bottom plate by securing fasteners through fastener holes. Respective top ends of the first jack leg and second jack leg are secured to a bottom side of the top member having an accessory mount 20, and a means to securely affix an accessory to the accessory mount 20 or accessory shank to the top member. In this embodiment, first and second jack legs are configured to form a space large enough for a jack, and more specifically, a drop leg jack. Also, the jack legs can have gussets 39 that are attached to the top side of the bottom plate and to the bottom ends of the jack legs 30, 31 respectively. These gussets 39 provide additional stability for the jack legs and prevent wobble. The jack is inserted through a hole in bottom plate. As shown the jack mounting plate has mounting holes usually three 35, that match with holes in the tongue and in the jack mounting plate. The base unit assembly is secured to the tongue by the addition of mounting bolts through the three holes whereby the mounting bolts secure the jack and the base unit assembly in their entirety and in addition to the tongue. This configuration solidly and securely affixes the cargo carrier Jack tower 11 to the vehicle tongue.

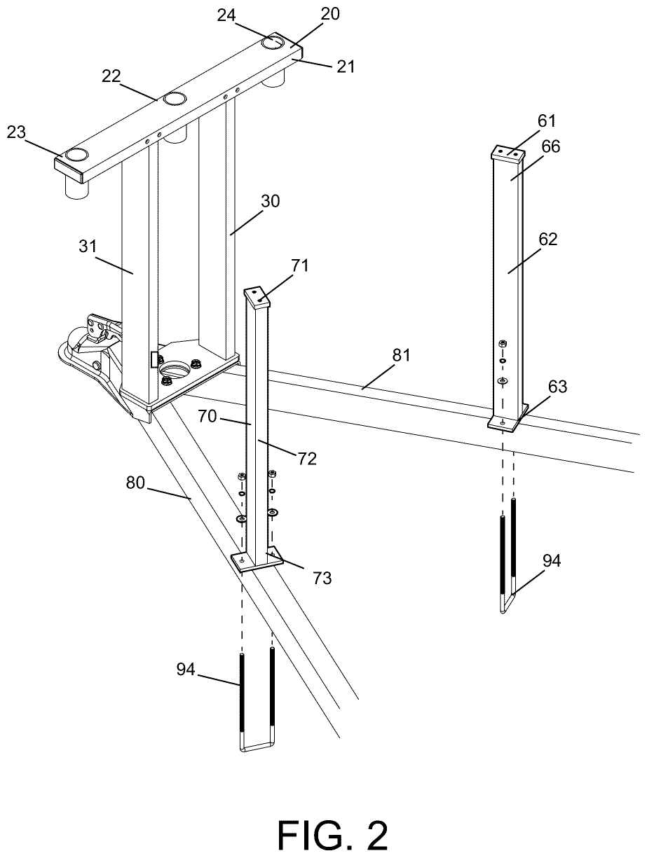

FIG. 6 specifically shows just the base unit assembly. This base unit assembly is the core of the cargo carrier apparatus and provides a solid, secure base to which the remainder of the cargo carrier is built. FIG. 7A shows a first embodiment of the jack tower base unit assembly 11 with the addition of the accessory exchange adapter, or accessory mounting member. This accessory mounting member 20 is attached and secured to the base unit assembly. This accessory mount is typically a hollow portion that is usually cylindrical, circular or square. In this embodiment, shown in FIG. 7A, the accessory exchange adapter is a square tube and is secured to the accessory mount using a pin. In an alternative embodiment the accessory exchange adapter is not used, but rather an alternative cargo accessory is secured directly to the base unit assembly at the jack tower mounting member 20 where the mounting member 20 features a variety of accessory mounting holes 24, as shown in FIG. 2. One such cargo accessory is described later as a table member, but it could be any of a variety of cargo accessories.

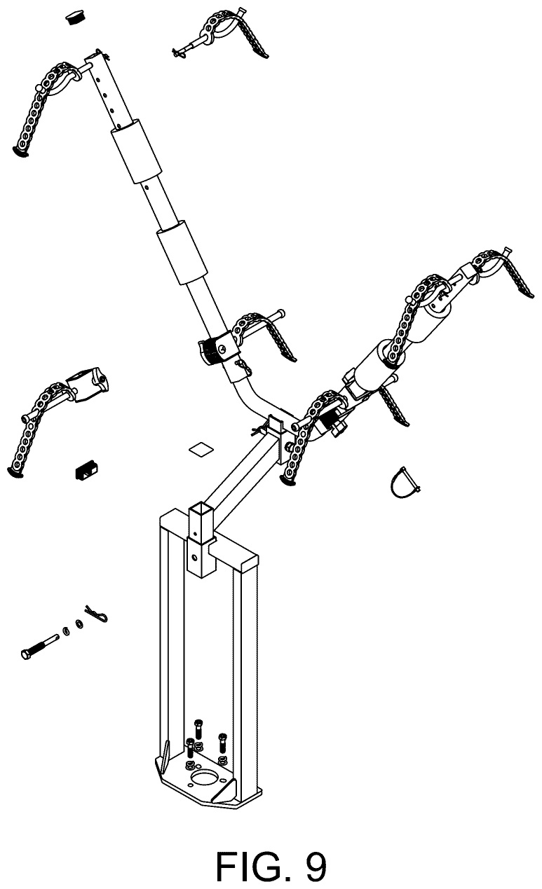

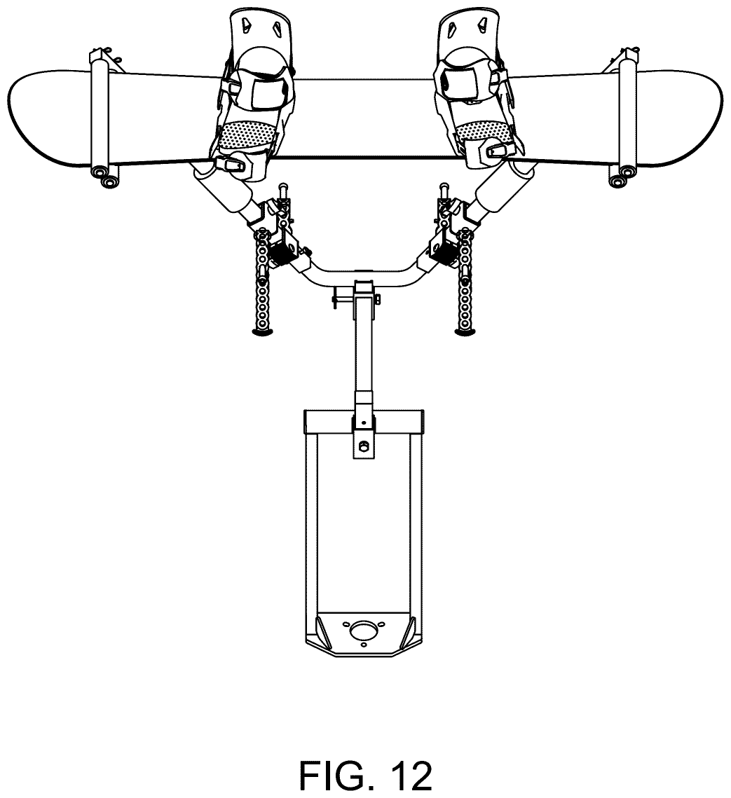

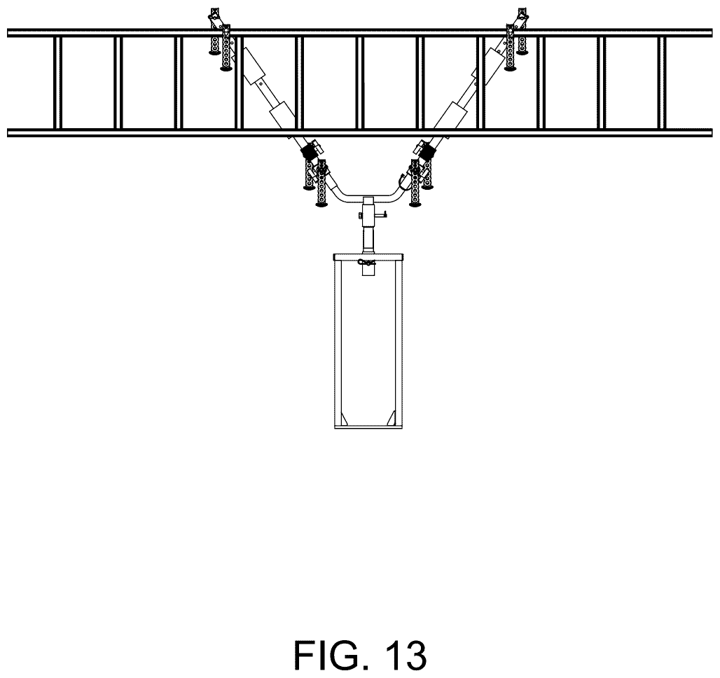

In FIG. 7B the cargo carrier apparatus is shown in an exploded view including base unit assembly shown in the lower portion, accessory exchange adapter shown apart from the base unit assembly and the Y receiver. In this embodiment, accessory exchange adapter has a post at a first end that is configured to matingly engage with a corresponding port of accessory mount. This post can be secured to the hole via locking pins or any other securement device that will allow the post to be inserted and then easily removed. Extending from the post is an arm that extends from the first end to an opposite end and in the opposite end is another receiving portion. This receiving portion is typically a hole that can receive any of a variety of lifestyle accessories. These lifestyle accessories can be a table, bicycle racks, kayak racks, bags, ski racks, tool racks or any other imaginable cargo carrying accessory. In the embodiment shown in FIG. 7B the receiving portion receives the above-described Y receiver. This member then receives another set of arm, or wing members, as is shown in FIGS. 9-13. Specifically, this arm set then forms a V shaped configuration of arm members. The arms are configured with hooks and securement straps whereby a bicycle or more can be hung on the hooks by the bicycle wheels and then the wheels are secured to the hooks using the securement straps. It should be noted however that the accessory is not restricted or limited to arms for hanging a bicycle. Alternatively, arm members are adaptable for use to hang or mount surf boards, snow boards, snow skis, water skis, weed whackers, yard tools, bags, kayaks and a plethora of other cargo carriers and equipment, as shown in FIG. 12-13.

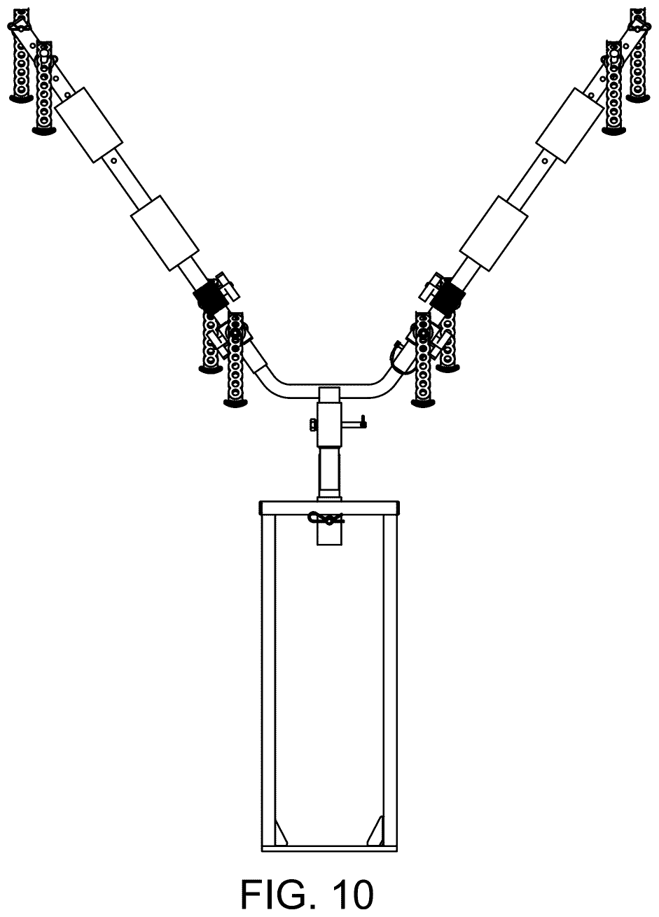

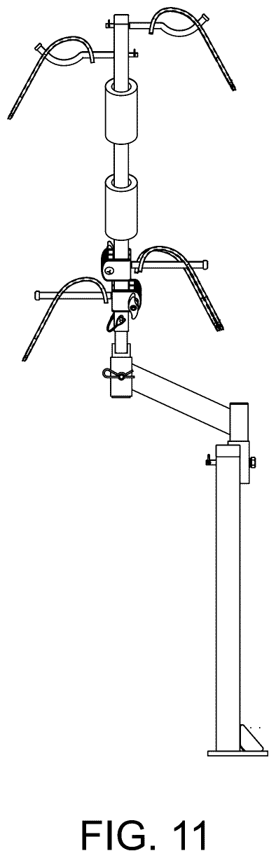

FIG. 10 is a frontal view of the cargo carrying apparatus with the base unit assembly, the accessory exchange adapter, the Y receiver and arm members attached. FIG. 11 is a side view of this same embodiment.

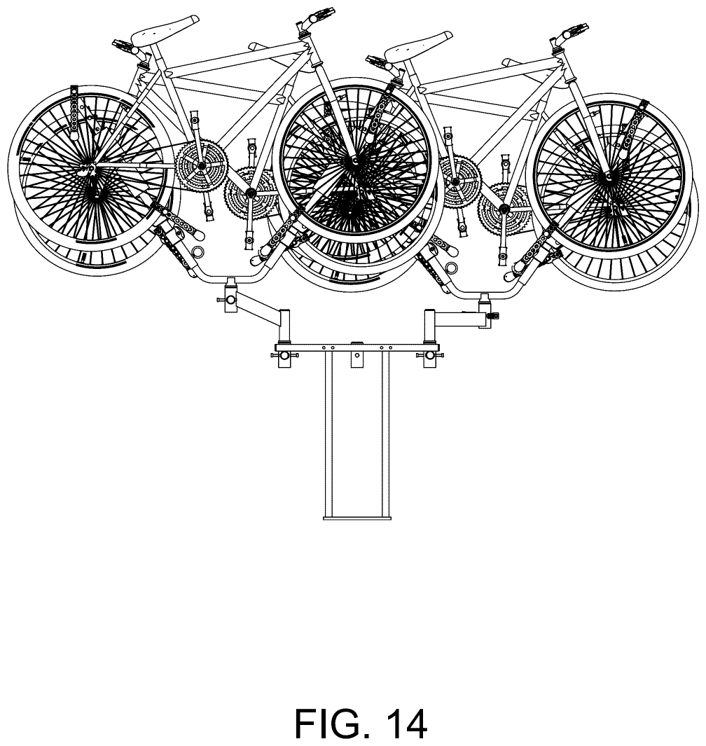

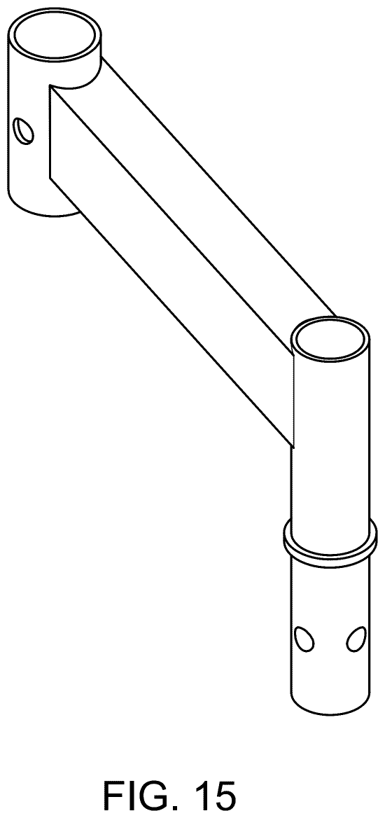

As demonstrate in FIGS. 9-14 there are alternative embodiments to the accessory exchange adapter. In a first embodiment shown in FIGS. 7A, 7B, 9-14, the tubing is square. When using this type of tubing the member is unmovable once inserted into accessory receiver mount due to the square configuration. However, it may be desirable to have the accessory exchange adapter moveable and adjustable about a variety of positions. To achieve this, it is possible to use round tubing instead of square tubing. As shown in FIG. 15, the extension member and the receiving portion may be circular ports. By using the circular orientation, it is much easier to adjust the extension members position. Pins or other securement devices can be used to lock the accessory exchange adapter into place. FIG. 12 shows the V-shaped rack when used with a snow board or water ski board and FIG. 13 shows the same rack but used alternatively with a ladder. FIG. 14 shows the rack with the capability to carry four bicycles. These images are meant to simply show that the cargo carrying apparatus has a multitude of uses and that it should not be restricted to bicycles only.

When used with a typical trailer jack the current invention can create storage space for items in a space and area that was previously inaccessible due to the jack being in the way. The present invention encompasses the jack and creates a mounting position on top of the jack in a space that was previously unusable. With the use of the base unit assembly a user can now store bicycles, skis, boards, work gear, bags, and a virtually unlimited number of items. In this embodiment, a retractable A-frame trailer jack is fastened onto a lower frame member comprising a planar surface and bolted into the three holes equally spaced adjacent a round slot perforation, hole, such that bolting down corresponding fastener holes in a ledge about the jack housing centers the drop leg over the slot, hole. The jack drop leg is thus released downward through the slot to prop and thereby support the trailer in a horizontally aligned, or level position, when the towing vehicle is detached. When not in use, the drop leg is retracted into a stored position within the jack housing, which is maintained in a stationary position in the rectangular pocket both in the afore described use or stored position. Juxtaposition of base unit assembly spaced apart from hitch ball a distance facilitates attachment and detachment of a trailer on and off hitch ball while also maintaining adequate clearance for loading, fastening, and unloading accessory mounts and cargo or equipment.

FIG. 14 illustrates a particular embodiment of the cargo carrying system with the addition of a four bike rack attached thereto. This rack features arms that pivot and extend outwardly or inwardly, are lockable in place, and are capable of carrying up to four bicycles by the wheels. In addition, the arms can be configured so that the outer portions of the arms are lockably connectable so that a table or platform can be installed on top of the now triangularly configured frame.

Potential configurations which may be employed to accommodate various vehicle and cargo types are too numerous and diverse to specify in detail herein. Variously configured and bulky items, such as bicycles, snowmobiles, dirt bikes, cargo boxes or even wheelchairs, may be attached by use of appropriate commercially available fasteners, such as, for example, bungee cords, pins and clamps, onto arms secured within the mounting members of the Y receiver above the rectangular pocket. As can be readily discerned, such fasteners could be readily adapted to attach equipment and cargo of various sizes. For example, the Y receiver may be adapted to transport skis and snowboards of successively shorter lengths by fastening them across the horizontal axis of the cargo carrier in order of descending lengths from the upper edge to the mounting bracket, the bottom of which could cradle a boot bag with boots secured onto the base plate. Similarly, water sports equipment and gear such as water skis, surfboards, and wake boards of successively descending lengths could be aligned and fastened along the arm members mounted on the Y receiver.

Alternative embodiments of the present invention may further include holes, notches, pockets or protrusions provided on the Y receiver or arm members for receiving and securing cargo.

Another aspect of the jack tower is provided by alternative embodiments employing various types of fasteners adaptable to differing recreational equipment, tools and other cargo. Such fasteners and supports include, without limitation, cradles for wheels or other suitably shaped structures, hooks, bungees, clamps, clips, clasps and elastomer cords. Fasteners and supports are pinned, looped, clamped or otherwise secured on the cargo carrier to accommodate differing sizes and shapes of the recreational equipment, tools and cargo cases. Yet further and alternative embodiments of the present invention include employing such fasteners to secure diverse cargo types, including construction and yard equipment, tools and supplies. For example, cradles and bungee cords may be secured to holes of the tubular arms and fastened about additional frame members, carriers, equipment or other cargo. Adjustment of fasteners and supports along the angular orientation of arm members facilitate versatile adaptation accommodation to differing types, sizes and shapes of cargo.

The present invention utilizes the jack tower and the accessory mounting member to create a secure, solid table. To accommodate this invention an elongated top member 20 is used and further includes a variety of circular accessory mounting holes 24 that allow for a number of different cargo carriers and for rotation. As can be seen in FIGS. 1-5, the top member extends past the parallel tower members jack legs 1 and 2, 30, 31. In this configuration there is a centrally located mounting hole and two additional mounting holes 24, one near the end of the opposing elongated top member 20. In this configuration the user can mount one or more racks, using one or more of the mounting holes.

FIG. 14 shows the elongated top member with two V-Shaped cargo racks mounted to the top mounting plate 20. This FIG. 14 clearly shows how to mount two V-shaped cargo racks, located at opposite ends of the extended, elongated top member. As can be seen, the mounting holes in this configuration are circular, thus allowing the rack members to easily rotate. This rotation makes it much easier to access both sides of the rack and makes it easier to load and unload cargo, such as bicycles.

FIGS. 1-5 show how to create the table accessory of the present invention. This is an accessory attachable to a jack tower 11, or jack tower add-on, that provides a fixed table accessory that is securely attachable to the jack tower. In a preferred embodiment the present invention, called “Stack-IT” 10 is a trailer accessory that utilizes the jack tower accessory mounting member 20 located at the top of the jack tower 11. The jack tower 11 in this embodiment has an elongated accessory top mounting member 20 affixed to a top of the jack tower 11 and it is preferable if this top member extends beyond the jack tower legs 30, 31. This mounting member 20 has a first side 21, a middle portion 22, a second side 23 and at least one accessory mounting hole 24. Next there is a first tray arm 40 having a first end 41 releasably connectable to the top mounting member 20, a middle portion 42 that extends outwardly from the first end 41 and parallel to a first leg 80 of an A-frame trailer, and a second end 43. There is a second tray arm 50 having a second tray arm first end 51 releasably connectable to the top mounting member 20, a second tray arm middle portion 52 that extends outwardly from the first end 51 and parallel to a second leg 81 of the A-frame trailer, and a second tray arm second end 53. Upright supports 60, 70 are used to secure and support the tray arms 40, 50. There is a first upright support 60 having a first end 61 releasably connectable to the first tray arm second end 43, a first upright support second end 63 that is releasably connectable to the first leg 80 of an A-frame trailer and that is parallel to a first leg 30 of the jack tower accessory mount and that is perpendicular to the first leg 80 of the A-frame trailer. A second upright support 70 has a first end 71 releasably connectable to the second tray arm second end 53, a second upright support second end 73 that is perpendicular to and releasably affixed to the second leg 81 of the A-frame trailer and that is parallel to a second leg of the jack tower accessory mount 31.

The first and second tray arms 40, 50 provide a solid, V shaped base for a table 90. In the preferred embodiment this table 90 is large enough to carry a generator. However, the table dimensions are only limited by the space behind the jack and the distance to the camper or whatever is built upon the A-frame trailer. To mount and affix the table 90 to the tray arms 40, 50 there are a plurality of mounting holes 92 in the tray arms, where the first tray arm 40 has a top side, a bottom side, and a plurality of first tray arm mounting holes 92. Next, the second tray arm 50 has a top side, a bottom side, and a plurality of second tray arm mounting holes 92. A plurality of fasteners 93 are used so that the plurality of fasteners 93 are inserted through the tray mounting holes 91, then through the tray arm mounting holes 92 to secure the tray to the first tray arm 40 and second tray arm 50. Once all the fasteners are in place and tight the table is ready for use.

This accessory is easy to install to the jack tower and it provides an incredibly solid base with a large load capacity. Because of the design it can easily carry heavy loads, such as generators. It is easy to install, requires minimal parts, and is relatively inexpensive to manufacture. It also creates a storage and holding space on the A-frame trailer that previously did not exist.

This is a unique design in that one side of a rectangular member is secured to the elongated top member of the jack tower where the side is supported by the jack tower legs and the opposite side of the rectangular member is supported by the two external support arms. These arms are attached to the table using the fasteners and then are attached to the trailer frame V member using one or more fasteners, ideally, a hat bracket, as seen in FIGS. 1-5. This creates an extremely solid platform for the table and also provides extreme weight bearing capacity.

Another accessory attachable to the jack tower is shown in FIGS. 16-17. This accessory creates one or more tables. The accessory is called the Table-IT. This is a system that provides for one or more tables, connectable to the jack tower that can act as tables or as securement shields or covers for cargo carried behind the jack tower. FIGS. 16-17 show how the table is secured to the jack tower. With square tubing, it is possible to install a table bottom tubing over a table mounting square tubing, thus creating an extremely solid platform that will not rotate, as shown in FIG. 17. When installed over the table mounting tubing in one direction it is possible to create an horizontal flat table top surface. However, it is also possible to remove the table with the square tubing, rotate the tubing 45 degrees, and slide the table bottom tubing over the table mounting tubing again, only this time the tabletop is now a vertical surface. An arm is connected to the outside circular receiver and is rotatable. When rotated outwardly the table surface now acts as a barricade, a wall or a protecting member. When both sides are configured in this manner they can fold and create walls to protect a propane tank or other cargo secured therebetween. This unique ability allows for the creation of one or more tabletops in one position and protective walls in another position.

Many features of the new products and inventions included in this application are used with the jack tower, now U.S. patent Ser. No. 10/576,902.

Features and embodiments of the present invention are numerous and diverse, extending beyond the detailed description and claims herein. For example, the Y receiver and its mounting members, as well as tubular arms of the present invention can be attached to other surfaces, items and containers not specified herein.

The cargo carrier system of another preferred embodiment further contemplates multiple carriers to be mounted onto one another to add additional capacity. Such latter embodiments may include extension shanks that connect carrier systems to one another.

It is to be expressly understood that other embodiments are considered to be within the scope of the present invention as set forth in the claims. Moreover, component configurations and combinations of embodiments may diverge from specifications shown and described. Thus, the scope of the present invention includes various substitutions and assemblies among the versatile and portable carrier systems beyond the particular embodiments illustrated and specified herein.

It is therefore contemplated that other embodiments not illustrated in the drawings or described herein are considered to be within the scope of the present invention as set forth in the final claims when eventually submitted. Accordingly, configurations and combinations of the components of the carriers shown and described not specifically shown may diverge from those specified herein. The scope of the present invention thus includes any equivalent configuration or combination of the embodiments described and elements claimed.

1. A trailer accessory, comprising:
a jack tower;
an elongated top mounting member affixed to a top of the jack tower having:
a first side;
a middle portion;
a second side;
at least one accessory mounting hole;
a first tray arm having:
a first end releasably connectable to the top mounting plate;
a middle portion that extends outwardly from the first end and parallel to a first leg of an A-frame trailer;
a second end;
a second tray arm having:
a second tray arm first end releasably connectable to the top mounting plate;
a second tray arm middle portion that extends outwardly from the first end and parallel to a second leg of the A-frame trailer;
a second tray arm second end;
a first upright support having:
a first end releasably connectable to the first tray arm second end;
a second end that is perpendicular to and releasably affixed to the first leg of an A-frame trailer and that is parallel to a first leg of the jack tower accessory mount;
a second upright support having:
a first end releasably connectable to the second tray arm second end;
a second end that is perpendicular to and releasably affixed to the second leg of an A-frame trailer and that is parallel to a second leg of the jack tower accessory mount.

2. The trailer accessory of claim 1, further comprising:
a tray.

3. The trailer accessory of claim 2, further comprising:
a plurality of mounting holes;
the first tray arm having:
a top side;
a bottom side;
a plurality of first tray arm mounting holes;
the second tray arm having:
a top side;
a bottom side;
a plurality of second tray arm mounting holes;
a plurality of fasteners; where
the plurality of fasteners are inserted through the tray mounting holes, then through the tray arm mounting holes, to secure the tray to the first tray arm and second tray arm.
